(19) United States
(12) Patent Application Publication
(10) Pub. No.: US 2009/0072941 A1
(43) Pub. Date: Mar. 19, 2009

(54) Bobbin for form coil

(75) Inventors: Youichi Hasegawa, Kasugai-shi (JP); Tomoya Imanishi, Oobu-shi (JP)

Correspondence Address: OLIFF & BERRIDGE, PLC, P.O. BOX 320850, ALEXANDRIA, VA, 22320-4850, US

(73) Assignee: DENSO CORPORATION, Kariya-City (JP)

(21) Appl. No.: 12/230,673

(22) Filed: Sep. 3, 2008

(30) Foreign Application Priority Data
Sep. 3, 2007 (JP) 2007-228117

(51) Int. Cl. H01F 27/06

(52) U.S. Cl. 336/65

(57) ABSTRACT

A bobbin has a primary surface member contacted to an inner periphery of a cylindrical yoke and a secondary surface member which faces the primary surface member. The primary and secondary surface members form an accommodating space part into which a form coil is accommodated. One or more inserting holes are formed in the primary and secondary surface members. The inserting holes correspond to boss parts of a pole core which correspond to coil parts of the form coil. A plurality of nail parts is formed around each inserting hole. An inserting hole is formed in the secondary surface member. When assembling the boss parts of the pole core into the bobbin, the plural nail parts are bent toward the inner direction of the inserting hole, and finally placed between the boss parts and the inner periphery of the coil parts of the form coil.

### CROSS-REFERENCE TO RELATED APPLICATION

This application is related to and claims priority from Japanese Patent Application No. 2007-228117 filed on Sep. 3, 2007, the contents of which are hereby incorporated by reference.

### BACKGROUND OF THE INVENTION

1. Field of the invention

The present invention relates to a bobbin for a form coil which is assembled as a field coil into the bobbin in a starter motor. The starter motor serves as a device for initiating the operation of an internal combustion engine of a vehicle.

2. Description of the Related Art

There have been proposed various types of form coils as field coils assembled in a direct current motor (a DC motor). One conventional form coil has a flat-type conductor wire which is arranged for winding the wire edgewise (hereinafter, referred to as the “edgewise wound coil”). For example, Japanese patent laid open publication No. JP 2006-271121 and Japanese patent publication No. JP 3737461 have disclosed such a form coil.

In particular, the latter conventional technique JP 3737461 has disclosed a method of assembling a resin bobbin between a form coil and a pole core when the form coil is assembled as a magnet pole of a motor into the pole core, and of directly winding the resin bobbin with a flat-type conductor wire. The resin bobbin serves as an insulator capable of electrically insulating the form coil from the pole core.

However, the flat-type conductor wire has a relatively large sectional area when compared with that of a round wire. In addition, because the flat-type conductor wire has a high rigidity when being wound edgewise, it requires a large amount of load when bending such a flat-type conductor wire. In order to avoid such a conventional drawback, JP 2006-271121 and JP 3737461 have disclosed a technique of directly winding a coil with a core wire therein on a resin bobbin. However, this conventional technique requires a thick bobbin with a high strength in order to avoid the bobbin from being damaged and deformed by the load generated when the flat-type conductor wire is bent. This leads the bobbin to have a large diameter, and as a result leads the entire length of the coil to being long. This further increases the entire electric resistance and thereby decreases the maximum output electric power.

In order to solve the above conventional problem, another conventional technique has been proposed in which a coil is directly wound around a core wire, and the coil with the core wire is assembled into a bobbin. Because this bobbin has flanges placed at both sides of the bobbin, it is difficult to insert the bobbin with the flanges through the inside of the form coil. This increases the time for the assembling work.

Still further, because the flanges formed at both sides of the bobbin are inserted into the inside of the form coil, it is difficult to increase the size of the flanges. Still further, when the flange has a small size, it is difficult to completely and electrically insulate the entire form coil from the pole core. In order to avoid such a conventional drawback, it is possible to use other types of flanges which are made as different parts from the bobbin, and the flanges are assembled into the bobbin. However, this technique increases the number of parts to be assembled, and increases the working cost of the form coil.

### SUMMARY OF THE INVENTION

It is an object of the present invention to provide a bobbin for a form coil without increasing the total number of parts of the bobbin, and capable of being easily assembled to the corresponding form coil.

To achieve the above purposes, the present invention provides a bobbin to be assembled between a form coil as a field coil and a pole core in a motor. The form coil has a coil part. The coil part is comprised of an edgewise wound coil obtained using a flat-type conductor wire arranged for winding a wire edgewise placed in an inner periphery of a cylindrical yoke of the motor. The pole core is comprised of a boss part and a flange part. The boss part is inserted in an inner periphery of the coil part of the form coil, and the flange part is formed at a base end of the boss part. The bobbin electrically insulates the form coil from the pole core. The bobbin according to the present invention has a primary surface member and a secondary surface member. In particular, the primary surface member is contacted to a surface of the inner peripheral of the cylindrical yoke. The secondary surface member faces in position to the primary surface member. The primary surface member and the secondary surface member form an accommodating space part in order to accommodate the form coil therein. An inserting hole is formed in the primary surface member and the secondary surface member. The boss part of the pole core is inserted into the inserting hole. A plurality of nail parts is formed at a periphery of the inserting hole of at least one of the primary surface member and the secondary surface member. The nail parts are bent toward the inner direction of the inserting hole and placed between the inner periphery of the coil part and the boss part of the pole core.

According to the present invention, the form coil has one or more coil parts. The coil part is comprised of an edgewise wound coil obtained using a flat-type conductor wire arranged for winding a wire edgewise. The coil part is placed in the inner periphery of the cylindrical yoke of the motor. The form coil is accommodated in the accommodating space part which is formed between the primary surface member and the secondary surface member. The primary surface member is contacted to the surface of the inner peripheral of the cylindrical yoke. The secondary surface member faces in position to the primary surface member. The boss part of the pole core is inserted into the inserting holes which are formed in the primary and secondary surface members corresponding to the coil part of the form coil. At this time, the plural nail parts formed at the periphery of the inserting hole of at least one of the primary surface member and the secondary surface member are bent toward the inner direction of the inserting hole. The plural nail parts are finally placed between the inner periphery of the coil part and the boss part of the pole core. The plural nail parts insulate the boss part of the pole core from the form coil. When the boss part of the pole core is inserted into the inserting hole of the bobbin, the flange part is contacted to the secondary surface member. This structure insulates the flange part of the pole core from the form coil.

That is, because only the plural nail parts, which are formed around the periphery of the inserting hole formed in the bobbin, are inserted into the inner periphery of the coil part of the form coil, this structure of the bobbin avoids the drawback of the conventional bobbin, namely, avoids the work of inserting the flange part of the bobbin into the inner periphery of the coil part which is required for the structure of the conventional bobbin having the flange part of a larger diameter than the inner diameter of the coil part.

On the other hand, according to the structure of the bobbin of the present invention, it is possible to easily assemble the bobbin to the form coil.

The conventional bobbin requires inserting the flange part of the bobbin into the inner periphery of the coil part of the form coil, the size of the flange part which is capable of insulating and protecting the side surface of the form coil is limited.

In the structure of the bobbin of the present invention, the side surface of the form coil is electrically insulated and protected by the primary and secondary surface members because the primary and secondary surface members has a larger area than the surface area of the form coil. Therefore even if the coil part is slightly shifted in position from the target position, it is possible to avoid failure of insulating the flange part of the pole core from the coil part of the form coil.

### BRIEF DESCRIPTION OF THE DRAWINGS

A preferred, non-limiting embodiment of the present invention will be described by way of example with reference to the accompanying drawings, in which:

FIG. 1 is a sectional view of a starter having a field winding in which the field winding is assembled into a bobbin according to an embodiment of the present invention;

FIG. 2 is a sectional view illustrating an assembled structure of the bobbin in which the field winding is assembled to a cylindrical yoke;

FIG. 3 is a development elevation of an inner peripheral part of the field winding which is assembled into the cylindrical yoke;

FIG. 4 is a view illustrating a cross section of the bobbin according to the embodiment of the present invention observed from an axial direction of a motor; and

FIG. 5 is a view illustrating the bobbin observed from the direction of arrow “A” shown in FIG. 4.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### Embodiment

A description will now be given of an embodiment of the bobbin for a form coil according to the present invention with reference drawings.

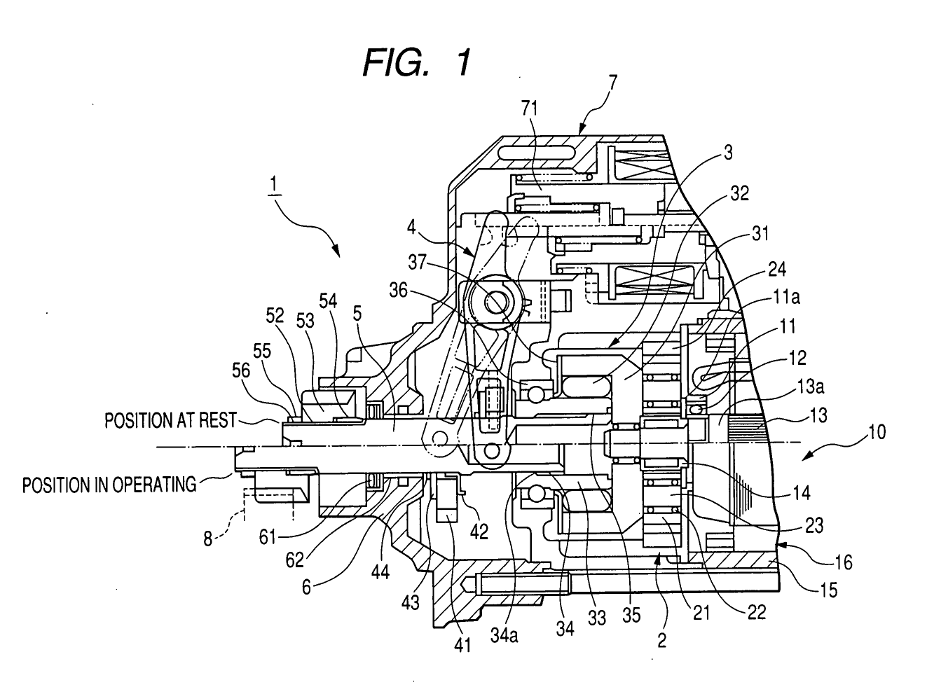

(Basic Structure of the Starter 1) FIG. 1 is a sectional view of a starter 1 having a field winding to which a bobbin according to an embodiment of the present invention is assembled.

The starter 1 is a starter of a speed reduction type with planet gears. The starter 1 is capable of starting the operation of an internal combustion engine mounted to a vehicle.

The starter 1 has a motor 10. The motor 10 is comprised of a cylindrical yoke 15, a field winding 16 to be assembled into an inner peripheral surface of the cylindrical yoke 15, and an armature 13. The armature 13 is rotatably placed in the inner peripheral surface of the field winding 16.

A plate-shape supporting member 11 (or a plate 11) supports an armature shaft of the armature 13 through a bearing 12. A stopper 11a is formed so that it contacts to the end surface of the bearing 12 in order to limit shifting the bearing 12 in the axial direction.

An armature gear 14 (or a sun gear 14) is placed at the end of the armature shaft 13a. This armature gear 14 is mated with a planet gear 21. The planet gear 21 orbits between the armature gear 14 and an internal gear 24 while turning on its own axis. The planet gear 21 is supported by a supporting shaft 23 through a needle bearing 22. The planet gear 21 reduces the rotation speed of the armature gear 14 and transmits the rotation power of the armature gear 14 to a clutch outer 31 of a clutch 3.

The clutch outer 31 transmits a torque to a clutch inner 33 (or a clutch tube) 33 through a roller 32. This clutch inner 33 is coupled to a helical spline 35 of a clutch shaft 5 with a helical spline 34.

The clutch shaft 5 is mated with the helical spline 34 and the helical spline 35. The clutch shaft 5 is shiftable in the clutch inner 33.

The helical spline 34 placed in the clutch inner 33 fixes the helical spline 35 of the clutch shaft 5 by a stopper 34a in order to stop shifting the helical spline 35.

The clutch shaft 5 is shiftably and rotatably supported by a bush 62 of a housing 6 and a ring washer 43 which is caulked in order to shift between the rest position and an operation position. The clutch shaft 5 is sealed with a seal 61 at the end of the bush 62.

A pinion 53 is mated with a ring gear 8 of the internal combustion engine. The pinion 53 is placed to the output shaft 5 through a direct spline 52. The output shaft 5 is supported by a stop collar 55 and a snap ring 56 using a pressure of a pinion spring 54.

A rolling contact surface is placed in the outer diameter of the clutch inner 33 at the pinion side. A ball bearing without an inner ring is placed around the outer periphery of the clutch inner 33 at the pinion 53 side. The clutch inner 33 and the clutch shaft 5 are rotatably supported by a frame 37.

A magnet switch 7 is comprised of a plurality of parts including the plunger 71.

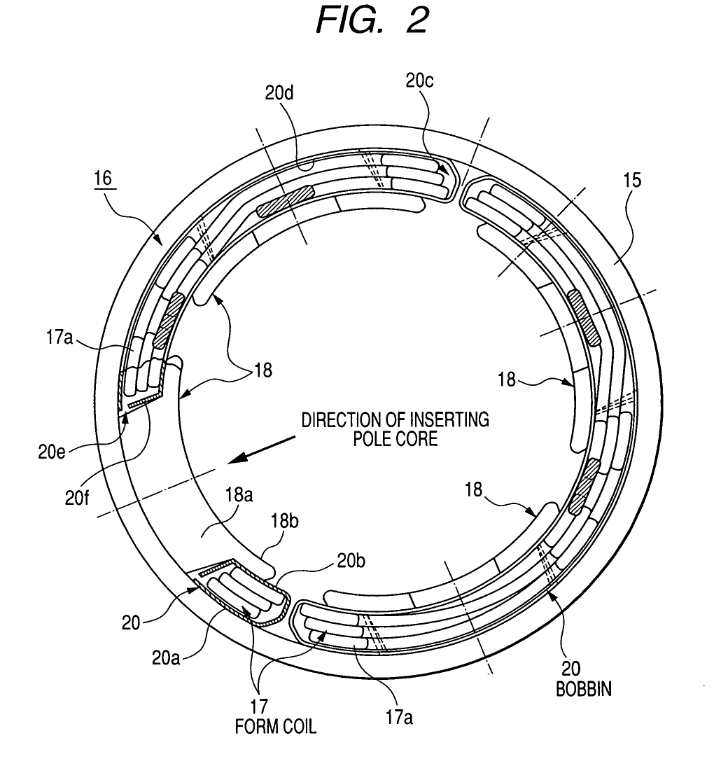

Next, a description will now be given of a structure of the field winding 16 which is assembled to the inner periphery of the cylindrical yoke 15 of the motor 10 in the starter 1 with reference to FIG. 2 to FIG. 5.

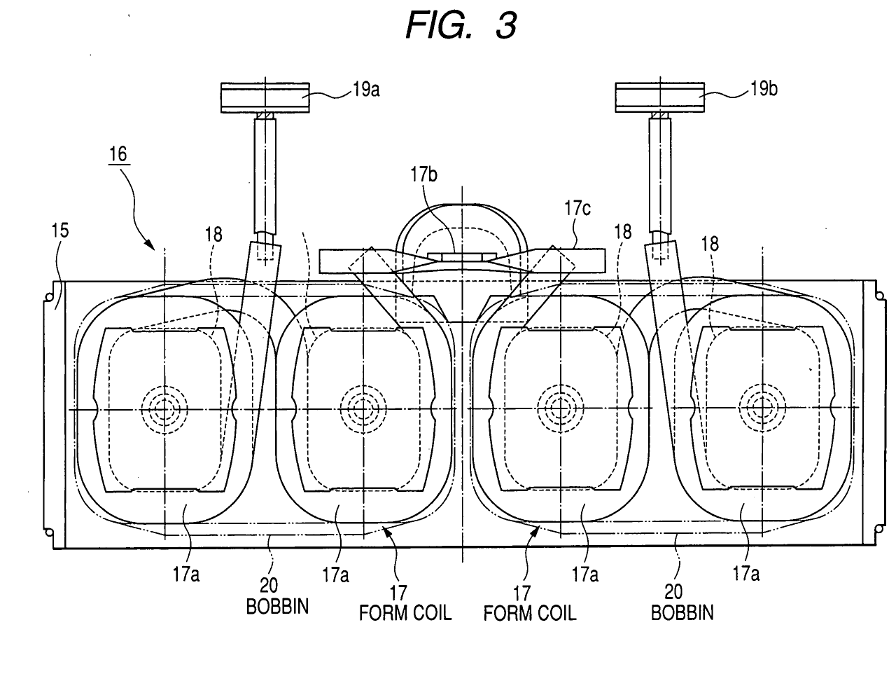

FIG. 2 is a sectional view illustrating the assembled structure in which the field winding 16 is assembled to the cylindrical yoke 15. FIG. 3 is a development elevation of an inner peripheral part of the field winding 16 which is assembled into the cylindrical yoke 15.

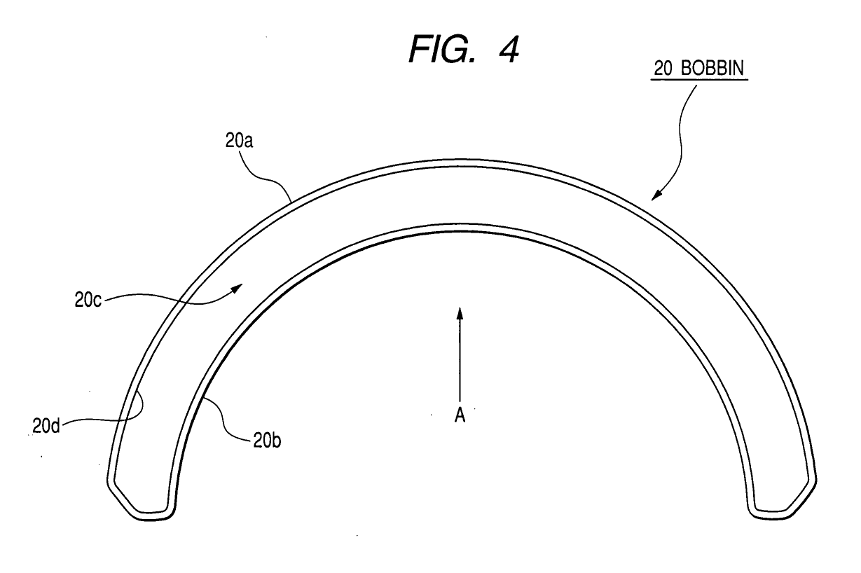

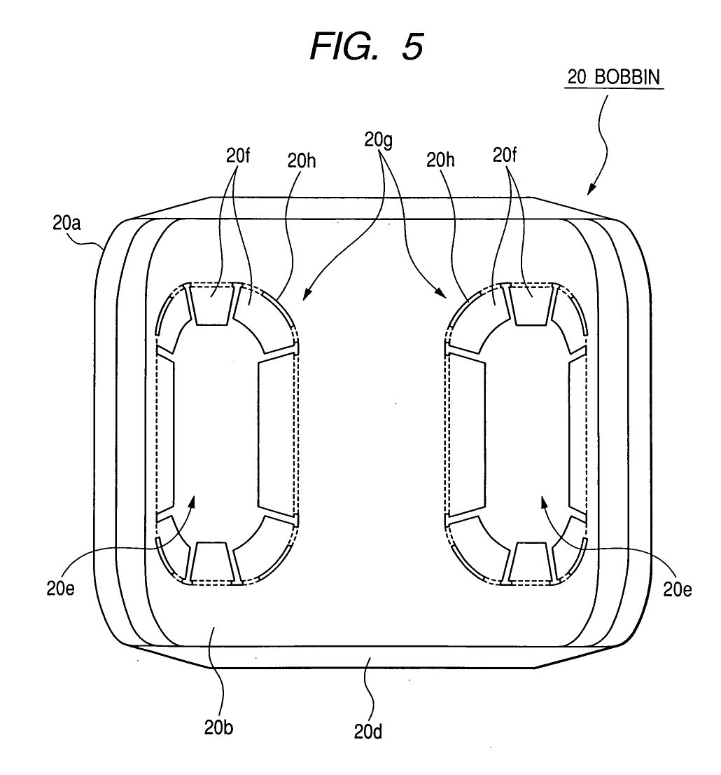

FIG. 4 is a view illustrating a cross section of the bobbin 20 in the motor 10 observed from the axial direction of the motor 10. FIG. 5 is a view illustrating the bobbin 20 in the motor 10 observed from the direction of arrow “A” shown in FIG. 4.

The field winding 16 has four poles shown in FIG. 2 and FIG. 3. The field winding 16 is comprised of two form coils 17 and four pole cores 18, and two bobbins 20.

Each of the bobbins 20 corresponds to a bobbin of a form coil written in claims under the “What is claimed” section according to the present invention.

Each form coil 17 has two coil parts 17a (as magnet poles). In each coil part 17a, a flat-type conductor wire is arranged for winding the wire edgewise. Each form coil 17 is shaped in a semicircular arc observed from the motor shaft side and placed along the inner peripheral surface of the cylindrical yoke 15 in order to place as the field winding coil in the inner periphery of the cylindrical yoke 15.

The “edgewise winding” means how to wind a flat-type conductor wire in the axial direction so that the flat-type conductor wires, which are adjacent to each other, are faced in a width wise direction.

In one of the two form coils 17, the flat-type conductor wire is wound in clockwise direction in order to form the two coil parts 17a. In another one of the two form coils 17, the flat-type conductor wire is wound in an anti-clockwise direction in order to form the two coil parts 17a. Thus, the two form coils 17 have the four coil parts 17a.

In other words, the field winding 16 has the four magnet poles in which the two form coils 17, each of which has the two magnet poles, are placed in the inner periphery of the cylindrical yoke 15. The end parts of the two form coils 17 are electrically connected together through a M-lead 17b and a crossover wire 17c. The other ends of the two form coils 17 are connected to a brush 19a and a brush 19b, respectively.

Each pole core 18 is comprised of a cylindrical boss part 18a and flange parts 18b. The cylindrical boss part 18a is inserted into the inner periphery of the coil part 17a of the form coil 17 in order to form a magnetic circuit. Each flange part 18b has a flange shape and is formed at the base end of the cylindrical boss part 18a.

Each bobbin 20 according to the embodiment of the present invention is a member made of synthetic resin. Each bobbin 20 electrically insulates the form coil 17 from each pole core 18. As shown in FIG. 4, each bobbin 20 has a semi-circular ark shape having a hollow part observed from the direction of the motor shaft.

Each bobbin 20 is comprised of a primary surface member 20a and a secondary surface member 20b. The primary surface member 20a is an outer peripheral part of the bobbin 20 which is contacted to the inner periphery of the cylindrical yoke 15. The secondary surface member 20b is an inner peripheral part of the bobbin 20 which is contacted to the flange parts 18b of the pole core 18. As shown in FIG. 2 and FIG. 4, the primary surface member 20a and the secondary surface member 20b are placed in a concentric arrangement and faced to each other. An accommodating space part 20c is formed between the primary surface member 20a and the secondary surface member 20b, as shown in FIG. 4. One form coil 17 is accommodated in the accommodating space part 20c. Each of the primary surface member 20a and the secondary surface member 20b are thin sheets, for example, having a thickness within a range of 1 mm to 2 mm.

Both the ends of the primary surface member 20a and the secondary surface member 20b in its circumference direction in each bobbin 20 are connected together and formed into one assembled body.

On the other hand, both the ends of the primary surface member 20a and the secondary surface member 20b in its axial direction (namely, in the axial direction of the starter motor 1) in each bobbin 20 make open parts 20d as shown in FIG. 4. The form coil 17 is inserted into the accommodating space part 20c through the corresponding open part 20d in the direction parallel to the primary surface member 20a and the secondary surface member 20b.

Two inserting holes 20e are formed in the primary surface member 20a and the secondary surface member 20b of the bobbin 20. Each inserting hole 20e has a rectangle shape, and each corner of the inserting hole 20e of a rectangle shape is rounded as shown in FIG. 5. The two inserting holes 20e correspond to the two coil parts 17a of the form coil 17 when one form coil 17 is accommodated in the accommodating space part 20c of the bobbin 20.

A plurality of nail parts 20f is formed around the whole circumference of the inserting hole 20e of the bobbin 20 at the inserting side of the boss part 18a of the pole core 18.

Each nail part 20f is easily bent at the bottom part thereof in the inside direction of the inserting hole 20e shown in FIG. 5. A long-thin absorbing hole 20h is formed along the bottom part of the nail part 20f at the rounded corner part 20g (or the R corner part 20g) of the inserting hole 20e through which the boss part 18a of the pole core 18 in inserted.

Next, a description will now be given of the method of assembling the field winding 16 into the bobbin 20.

First, the form coil 17 composed of the two coil parts 17a is assembled into the bobbin 20. Specifically, the form coil 17 is inserted into the accommodating space part 20c through the open part 20d in the direction which is parallel to the primary surface member 20a and the secondary surface member 20b. Before inserting the form coil 17 into the accommodating space part 20c of the bobbin 20, because the plural nail parts 20f are out in position of the inserting holes 20e (namely, out of the accommodating space part 20c), it could not be an obstacle in inserting the form coil 17. It is therefore possible to smoothly and easily insert and accommodates the form coil 17 into the accommodating space part 20c.

Following this, each pole core 18 is assembled into the corresponding bobbin 20. Specifically, the cylindrical boss part 18a of the pole core 18 is inserted into the inside of the inserting hole 20e from the secondary surface member 20b. At this time, the plural nail parts 20f formed at the periphery edge portion of the inserting holes 20e are bent toward the inside of the inserting holes 20e, so that the plural nail parts 20f are placed between the inner periphery of the coil part 17a of the form coil 17 and the cylindrical boss part 18a of the pole core 18. This electrically insulates the inner periphery of the coil part 17a of the form coil 17 from the cylindrical boss part 18a of the pole core 18.

The flange parts 18b of the pole core 18 are contacted to the secondary surface member 20b, so that the form coil 17 is thereby electrically insulated from the flange parts 18b of the pole core 18.

Next, a description will now be given of the operation of the starter 1.

Before starting the starter 1, the clutch shaft 5 is at the rest position of the clutch shaft 5 shown in FIG. 1. When a starter switch (not shown) is turned ON, a lever device 4 is oscillatory shifted by the plunger 71 of the magnet switch 7.

The pinion 53 on the clutch shaft 5 is mated with the ring gear 8 through the ring 41, a ring washer 42, a washer 43, and a C-type cir clip 44. As a result, the internal combustion engine (not shown) starts at the operation position. At the start of the starter 1, the rotation power of the motor 10 is reduced by the armature gear 14, the planet gear 21, and the internal gear 24. The reduced rotational power of the motor 10 is transmitted to the clutch outer 31 of the clutch 3.

The clutch outer 31 transmits the output torque of the motor 10 to the clutch inner 33 through the roller 32. The clutch inner 33 transmits the torque to the helical spline 35 of the clutch shaft 5 through the helical spline 34. At this time, the clutch shaft 5 is pushed by the reciprocation power of the lever device 4, the helical splines 34 and 35 toward the ring gear 8 side. The pinion 53 is thereby mated with the ring gear 8. The internal combustion engine thereby initiates its operation by the output torque of the starter 1 at the operation position shown in FIG. 1.

After the start of the internal combustion engine, the starter switch (not shown) is turned OFF, the plunger 71 of the magnet switch 7 is returned to its original position. The clutch shaft 5 is returned to its original position by the lever device 4, and the starter 1 then stops.

As described above in detail, the bobbin 20 according to the embodiment of the present invention is assembled between the form coils 17 and the pole cores 18 in order to electrically insulate the form coils 17 from the pole cores 18. Each form coil 17 has the coil parts 17. Each coil part 17 is made of a flat-type conductor wire which is wound edgewise. The boss part 18a of the pole core 18 is inserted into the inner periphery of the corresponding coil part 17a of the form coil 17. The pole core 18 has the flange part 18b formed at the base end of the boss part 18a.

The bobbin 20 has the primary surface member 20a and the secondary surface member 20b. The primary surface member 20a is contacted to the inner periphery of the cylindrical yoke 15. In the bobbin 20, the secondary surface member 20b faces in position the primary surface member 20a. The accommodating space part 20c is formed between the primary surface member 20a and the secondary surface member 20b. Each form coil 17 is placed in the corresponding accommodating space part 20c. The inserting holes 20e are formed in the primary surface member 20a and the secondary surface member 20b. The boss part 18a of the pole core 18 is inserted into and placed in the corresponding inserting holes 20e.

The plural nail parts 20f are formed at the periphery of the accommodating space part 20c of the secondary surface member 20b. The plural nail parts 20f are bent toward the inside of the inserting holes 20e when the boss part 18a of the pole core 18 is inserted into the accommodating space part 20c. Those plural nail parts 20f are placed between the inner periphery of the coil part 17a and the boss part 18a of the pole core 18 in the starter 1. This structure enables the boss part 18a of the pole core 18 from being electrically insulated form the form coil 17.

Because the boss part 18a of the pole core 18 is inserted into the inserting holes 20e of the bobbin 20, each flange part 18b is contacted to the secondary surface member 20b, and as a result, the form coil 17 is electrically insulated from the flange parts 18b of the pole core 18 by the bobbin 20. That is, in the bobbin 20 according to the embodiment of the present invention, only the plural flange parts 20f formed at the periphery of the inserting holes 20e are inserted into the inner periphery of the coil part 17a of the form coil 17. The structure of the bobbin 20 according to the embodiment of the present invention described above eliminates the work of inserting the flange parts into the inner periphery of the form coil which is necessary for a conventional bobbin having one or more flange parts, each flange part is larger in diameter than the inner diameter of the coil part of the form coil.

Using the bobbin 20 according to the embodiment of the present invention provides the easy work of assembling the form coils 17 into the bobbins 20 and the pole cores 18 into the bobbin 20.

The structure of the conventional bobbin limits the size of the flange part capable of electrically insulating the side surfaces of the form coil.

On the other hand, the structure of the bobbin 20 according to the embodiment of the present invention enables the side surfaces of the form coil 17 to be electrically insulated by the primary surface member 20a and the secondary surface member 20b. It is thereby possible to prevent the form coil from insulating failure even if the position of the form coil in the bobbin 20 is slightly shifted.

In addition, the primary surface member 20a and the secondary surface member 20b are connected together in order to form one assembled body through the end parts thereof (at the end parts in the circumference direction thereof). On the other hand, the other edges of the primary surface member 20a and the secondary surface member 20b (in the axial direction of the motor shaft of the starter motor 1) form the opening parts 20d. This provides easy work of inserting and accommodating the form coil 17 in the accommodating space part 20c of the bobbin 20 through the corresponding open part 20d in the direction which is parallel to the primary surface member 20a and the secondary surface member 20b.

Further, according to the bobbin 20 of the embodiment, the primary surface member 20a is so formed that it bent along the inner circumferential surface of the cylindrical yoke 15. The secondary surface member 20b is also bent so that the primary surface member 20a and the secondary surface member 20b are placed in a concentric arrangement and faced to each other. This structure enables the form coil 17 to be easily inserted into the accommodating space part 20c.

Still further, according to the bobbin 20 of the embodiment, the plural nail parts 20f are formed at the periphery of the inserting holes 20e in the secondary surface member 20b through which the boss part 18a of the pole core 18 is inserted into the bobbin 20. The plural nail parts 20f are simultaneously bent toward the inner direction of the inserting holes 20e while inserting the boss part 18a of the pole core 18 into the inserting holes 20e. This efficiently enhances the assembling work.

Still further, according to the bobbin 20 of the embodiment, before the assembling work of the pole core 18, the plural nail parts 20f are positioned out of the inserting holes 20e. When the boss part 18a of the pole core 18 is inserted into the corresponding inserting holes 20e after accommodating the form coil 17 into the accommodating space part 20c, the plural nail parts 20f are thereby bent toward the inner direction of the inserting holes 20e. Thus, because the plural nail parts 20f are positioned out of the inserting holes 20e (namely, out of the accommodating space part 20c) before accommodating the form coil 17 into the accommodating space part 20c, the plural nail parts 20f could not be obstacles in inserting the form coil 17 into the accommodating space part 20c. It is therefore possible to easily insert the form coil 17 into the accommodating space part 20c. After this, the plural nail parts 20f are bent toward the inner direction of the inserting holes 20e in order to place the plural nail parts 20f between the inner periphery of the coil part 17a and the boss part 18a of the pole core 18.

Still further, each form coil 17 has a plurality of coil parts (for example, the two coil parts 17a in the embodiment). A plurality of inserting holes 20e is formed in the primary surface member 20a and the secondary surface member 20b according to the number of the coil parts 17a of each form coil 17. The plural nail parts 20f are formed at the periphery of the inserting holes 20e in the secondary surface member 20b. It is thereby possible to simultaneously assemble the plural poles (as the coil parts 17a) into the bobbins 20. This enhances the efficiency of assembling work.

Still further, the rounded corner parts 20g (or the R corner parts 20g) are formed at the periphery of the inserting holes 20e shown in FIG. 5, and the long-thin absorbing holes 20h are formed along the bottom part of the nail parts 20f which are formed at the rounded corner parts 20g (or the R corner part 20g), distortion generated when the nail parts 20f are bent toward the inserting holes 20e can be absorbed by the long-thin absorbing holes 20h. It is thereby possible to bend the nail parts 20f along the R-shaped periphery, and also possible to cover the boss part 18a of the pole core 18 with the rounded corner parts 20g (or the R corner parts 20g).

Accordingly, it is possible to avoid the difficulty of assembling the form coil 17 caused by deforming the primary surface member 20a or the secondary surface member 20b, and also possible to avoid failure such as expansion crack and deformation. The structure of the bobbin according to the embodiment of the present invention provides the efficient assembling work for form coils.

The concept of the present invention is not limited by the above embodiment. For example, the concept of the bobbin 20 according to the present invention is applied to a bobbin for a form coil of a single pole or three poles or more than three poles.

It is possible to apply the structure of the bobbin according to the present invention without increasing the number of components and with easy assembling work for assembling the form coils into the bobbin.

### OTHER EFFECTS OF THE INVENTION

In the bobbin as another aspect of the present invention, one end of the primary surface member and one end of the secondary surface member are connected together, and the other end along the longitudinal direction of the primary surface member and the other end along the longitudinal direction of the secondary surface member form an open part through which the form coil is inserted into and placed in the accommodating space part.

According to the present invention, because one end of the primary surface member and one end of the secondary surface member are connected together into one assembled body, and because the other end along the longitudinal direction of the primary surface member and the other end along the longitudinal direction of the secondary surface member form an open part, it is possible to easily insert and accommodate the form coil into the accommodating space part from the open part in the bobbin without increasing the number of components which form the bobbin.

In the bobbin as another aspect of the present invention, it is so formed that the primary surface member curves along the shape of the inner peripheral surface of the cylindrical yoke.

Further, the secondary surface member and the primary surface member are placed in a concentric arrangement so that the inner surface of the secondary surface member faces the inner surface of the primary surface member.

According to the present invention, because it is so formed that the primary surface member curves along the shape of the inner peripheral surface of the cylindrical yoke, and because the secondary surface member and the primary surface member are placed in a concentric arrangement so that the inner surface of the secondary surface member faces the inner surface of the primary surface member, it is possible to certainly and easily accommodate the form coil, which is formed to be accommodated in the cylindrical yoke, into the accommodating space part.

In the bobbin as another aspect of the present invention, the plural nail parts are formed around the inserting hole in the secondary surface member.

According to the present invention, because the plural nail parts are formed around the inserting hole in the secondary surface member, it is possible to bend the nail parts toward the inserting hole simultaneously when inserting the boss part of the pole core into the inserting hole, and also possible to enhance the efficiency of work of assembling the form coil into the bobbin.

In the bobbin as another aspect of the present invention, the plural nail parts are bendable toward the inside direction of the accommodating space part after the form coil is inserted and accommodated in the accommodating space part.

According to the present invention, because the plural nail parts are positioned at the outside of the inserting holes (namely, the plural nail parts are out in position of the accommodating space part) before the form coil is accommodated into the accommodating space part, those nail parts could not be an obstacle when inserting the form coil into the accommodating space part. It is therefore possible to easily insert the form coil into the accommodating space part. Further, the plural nail parts are bent toward the inserting hole and finally placed between the inner periphery of the coil part of the form coil and the boss part of the pole core after assembling the form coil into the accommodating space part.

In the bobbin as another aspect of the present invention, the form coil has the plural coil parts, and the plural inserting holes are formed in the primary surface member and the secondary surface member, and the plural nail parts are formed at the periphery of the inserting hole of at least one of the primary surface member and the secondary surface member.

According to the present invention, because the plural inserting holes are formed in the primary surface member and the secondary surface member corresponding to each coil part of the form coil, and because the plural nail parts are formed at the periphery of the inserting hole of at least one of the primary surface member and the secondary surface member, it is possible to assemble the coil parts into the corresponding bobbin simultaneously, and thereby possible to enhance the efficiency of the assembling work.

In the bobbin as another aspect of the present invention, a rounded part (a R part) is formed at least a part around of the inserting hole, and an absorbing hole is formed at a base of each nail part formed at the R part.

According to the present invention, because the R part is formed at least a part around of the inserting hole, and because the absorbing hole is also formed at the base of each nail part formed at the R part, the absorbing hole absorbs distortion generated when the nail parts are bent toward the inside of the inserting hole, and the nail parts can be bent in curve shape along the peripheral shape of the R part. It is possible to avoid the difficulty of assembling the form coil by deforming the primary surface member or the secondary surface member, and also possible to avoid failure such as expansion crack and deformation. The structure of the bobbin according to the present invention provides the efficient assembling work for form coils.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalent thereof.

What is claimed is:

1. A bobbin to be assembled between a form coil as a field coil and a pole core in a motor, the form coil having a coil part, the coil part being comprised of an edgewise wound coil obtained using a flat-type conductor wire arranged for winding a wire edgewise placed in an inner periphery of a cylindrical yoke of the motor, the pole core comprised of a boss part and a flange part, the boss part being inserted in an inner periphery of the coil part of the form coil, and the flange part being formed at a base end of the boss part, the bobbin electrically insulating the form coil from the pole core,
bobbin comprising:
a primary surface member; and
a secondary surface member, wherein
the primary surface member is contacted to a surface of the inner peripheral of the cylindrical yoke,
the secondary surface member faces in position to the primary surface member,
the primary surface member and the secondary surface member form an accommodating space part in order to accommodate the form coil therein, and
an inserting hole is formed in the primary surface member and the secondary surface member, the boss part of the pole core is inserted into the inserting hole, and
a plurality of nail parts is formed at an periphery of the inserting hole of at least one of the primary surface member and the secondary surface member, and the nail parts are bent toward the inner direction of the inserting hole and placed between the inner periphery of the coil part and the boss part of the pole core.

2. The bobbin according to claim 1, wherein one end of the primary surface member and one end of the secondary surface member are connected together, and the other end along the longitudinal direction of the primary surface member and the other end along the longitudinal direction of the secondary surface member form an open part through which the form coil is inserted into and placed in the accommodating space part.

3. The bobbin according to claim 1, wherein it is so formed that the primary surface member curves along the shape of the inner peripheral surface of the cylindrical yoke, and the secondary surface member and the primary surface member are placed in a concentric arrangement so that the inner surface of the secondary surface member faces the inner surface of the primary surface member.

4. The bobbin according to claim 2, wherein it is so formed that the primary surface member curves along the shape of the inner peripheral surface of the cylindrical yoke, and the secondary surface member and the primary surface member are placed in a concentric arrangement so that the inner surface of the secondary surface member faces the inner surface of the primary surface member.

5. The bobbin according to claim 1, wherein the plural nail parts are formed around the inserting hole in the secondary surface member.

6. The bobbin according to claim 2, wherein the plural nail parts are formed around the inserting hole in the secondary surface member.

7. The bobbin according to claim 3, wherein the plural nail parts are formed around the inserting hole in the secondary surface member.

8. The bobbin according to claim 1, wherein the plural nail parts are bendable toward the inside direction of the accommodating space part after the form coil is inserted and finally accommodated in the accommodating space part.

9. The bobbin according to claim 2, wherein the plural nail parts are bendable toward the inside direction of the accommodating space part after the form coil is inserted and finally accommodated in the accommodating space part.

10. The bobbin according to claim 3, wherein the plural nail parts are bendable toward the inside direction of the accommodating space part after the form coil is inserted and finally accommodated in the accommodating space part.

11. The bobbin according to claim 1, wherein the form coil has the plural coil parts, and the plural inserting holes are formed in the primary surface member and the secondary surface member, and the plural nail parts are formed at the periphery of the inserting hole of at least one of the primary surface member and the secondary surface member.

12. The bobbin according to claim 2, wherein the form coil has the plural coil parts, and the plural inserting holes are formed in the primary surface member and the secondary surface member, and the plural nail parts are formed at the periphery of the inserting hole of at least one of the primary surface member and the secondary surface member.

13. The bobbin according to claim 3, wherein the form coil has the plural coil parts, and the plural inserting holes are formed in the primary surface member and the secondary surface member, and the plural nail parts are formed at the periphery of the inserting hole of at least one of the primary surface member and the secondary surface member.

14. The bobbin according to claim 1, wherein a rounded part (a R part) is formed at least a part around of the inserting hole, and an absorbing hole is formed at a base of each nail part formed at the R part.

15. The bobbin according to claim 2, wherein a rounded part (a R part) is formed at least a part around of the inserting hole, and an absorbing hole is formed at a base of each nail part formed at the R part.

16. The bobbin according to claim 3, wherein a rounded part (a R part) is formed at least a part around of the inserting hole, and an absorbing hole is formed at a base of each nail part formed at the R part.
